(19) United States
(12) Patent Application Publication
(10) Pub. No.: US 2014/0243067 A1
(43) Pub. Date: Aug. 28, 2014

(54) VIDEO DISPLAY WITH WINDOW OPENING

(71) Applicant: IGT, Reno, NV (US)

(72) Inventors: Gregory A. Silva, Reno, NV (US); Chauncey W. Griswold, Reno, NV (US)

(73) Assignee: IGT, Reno, NV (US)

(21) Appl. No.: 13/777,521

(22) Filed: Feb. 26, 2013

(51) Int. Cl. G02F 1/1335

(52) U.S. Cl. CPC G02F 1/133606
USPC 463/20; 349/65; 349/33; 349/12; 463/31

(57) ABSTRACT

A video display having a window opening includes a graphic display portion configured to display graphical indicia, one or more light sources, and a light guide. The light guide is configured to receive light from the one or more light sources and provide the light as backlighting to the graphic display portion. The light guide also includes a light guide shutter configured to selectably transition between a closed state and a transparent state. The light guide shutter is configured to allow a user to see through the electronic display when the light guide shutter is in its transparent state.

### BACKGROUND

1. Field of the Described Embodiments

The present disclosure relates generally to video displays. The present disclosure particularly relates to a video display having a selectably transparent window opening.

2. Description of the Related Art

Traditional mechanical slot machines often include mechanical reels that spin when a lever of the machine is actuated. In response to a player pulling the lever, a spring-mounted cam plate is released, allowing the mechanical reels to spin freely. Eventually, the cam plate returns to position, causing stoppers to contact grooves of the reels again, thereby stopping the reels. If certain grooves align, the slot machine pays out a predetermined amount. From the player's perspective, symbols on the reels would appear in a certain ordering based on the alignment of the reels' grooves. For example, 7-7-7 may appear to a player across a payline to indicate that the player has won a jackpot.

The reels displayed to players in modern computerized slot machines fall into two general categories: electro-mechanical reels and video reels. Electro-mechanical reels typically look similar to the mechanical reels of early slot machines, but are controlled via electrical means. For example, a stepper motor may control the spinning of the electro-mechanical reels based on output of a random number generator (RNG). Video reels, in contrast, are simply reel graphics provided to an electronic display to simulate the spinning of physical reels. Based on the results of the slot machine's random number generator, the reel graphics may display a resulting symbol combination. While video slot machines allow for various graphics and effects to be displayed on screen, some players still prefer the nostalgia associated with slot machines having physical reels.

Many modern electronic displays include a light guide layer. In general, a light guide is configured to distribute illumination uniformly across the screen of the display. For example, an LCD display may be lit by an illumination source. Without a light guide, the portions of the screen closest to the illumination sources would receive more lighting than the portions that are farthest away from the sources. With a light guide, light may be internally reflected along the light guide until it exits in a direction towards the LCD screen.

Some attempts have been made to combine an electronic display and electro-mechanical reels into a hybrid gaming machine. Such hybrid machines generally have electro-mechanical reels located behind an electronic display. In a first mode, the reels are visible through window openings made in the layers of the electronic display. In a second mode, graphics are provided on the display on top of the window openings. However, previous approaches form the window openings by also cutting holes into the display's light guide. As a result, lighting is not distributed evenly across the screen in the areas surrounding the cutouts. In addition, the lack of a light guide in these areas also results in the electro-mechanical reels being slightly visible through the display, even when the display is in a video mode.

### SUMMARY

According to one embodiment, an electronic display includes a graphic display portion configured to display graphical indicia, the electronic display also including a light source and a light guide. The light guide is configured to receive light from the light source and provide the light as backlighting to the graphic display portion. The light guide includes a light guide shutter configured to selectably transition between a closed state and a transparent state. The light guide shutter is configured to allow a user to see through the electronic display when the light guide shutter is in its transparent state. The light guide shutter also diffuses the light to provide backlighting to the graphic display portion when the light guide shutter is in its closed state.

According to another embodiment, an electronic gaming machine includes a cabinet and an electronic display housed by the cabinet. The electronic gaming machine also includes one or more electro-mechanically controlled devices housed by the cabinet and located between the electronic display and the cabinet. The electronic gaming machine further includes processing circuitry configured to provide graphics to the electronic display and to control the one or more electro-mechanically controlled devices. The electronic display includes a light guide having a light guide shutter configured to selectably transition between a closed state and a transparent state. The electro-mechanically controlled devices are visible through a portion of the electronic display when the light guide shutter is in its transparent state. The light guide also provides backlighting to the electronic display when light guide shutter is in its closed state.

According to a further embodiment, a light guide is configured to receive light from a light source and provide the light as backlighting to an electronic display. The light guide includes an inactive portion having light extraction features configured to direct the light received from the light source. The light guide also includes a light guide shutter configured to selectably transition between a closed state and a transparent state. The light guide shutter is configured to allow a user to see through the electronic display when the light guide shutter is in its transparent state. The light guide shutter is also configured to direct light as backlighting to the graphic display portion when the light guide shutter is in its closed state.

### BRIEF DESCRIPTION OF THE DRAWINGS

The details of one or more implementations are set forth in the accompanying drawings and the description below. Other features, aspects, and advantages of the disclosure will become apparent from the descriptions, the drawings, and the claims, in which:

FIG. 1 is an illustration of a gaming machine with a video display having selectably transparent window openings, according to an exemplary embodiment;

FIG. 2 is an illustration of the video display of the gaming machine of FIG. 1 in greater detail, according to an exemplary embodiment;

FIG. 3 is an illustration of the window openings of the display of FIG. 2 in a transparent state, according to an exemplary embodiment;

FIG. 4. is an illustration of the window openings of the display of FIG. 2 in a closed state, according to an exemplary embodiment;

FIG. 5 is a schematic diagram of a video display having a selectably transparent light guide shutter, according to an exemplary embodiment;

FIG. 6 is a diagram of light being propagated in a light guide, according to an exemplary embodiment; and

FIG. 7 is a diagram of a light guide having light extraction features and a shutter window area, according to an exemplary embodiment.

Like reference numbers and designations in the various drawings indicate like elements.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept.

According to various embodiments, a hybrid slot machine may include a display that has one or more selectably transparent window openings in its light guide. In one state, the window openings may be transparent, allowing a player of the slot machine to see electro-mechanical reels or other objects through the window openings of the display. In a second state, the window openings may be closed, allowing the video display to show graphics instead of the electro-mechanical reels or other objects located behind the display. While closed, the window openings in the light guide may also provide illumination to the display, thereby allowing the display to be backlit in the area of the window openings. Thus, the light guide may still provide backlighting to the display in the area of the window openings, when the window openings are in a closed state. Direction of light towards the screen of the display in the areas of the window openings may also prevent the electro-mechanical reels or other objects from being partially visible to a user, when graphics are provided on the screen in front of the window openings.

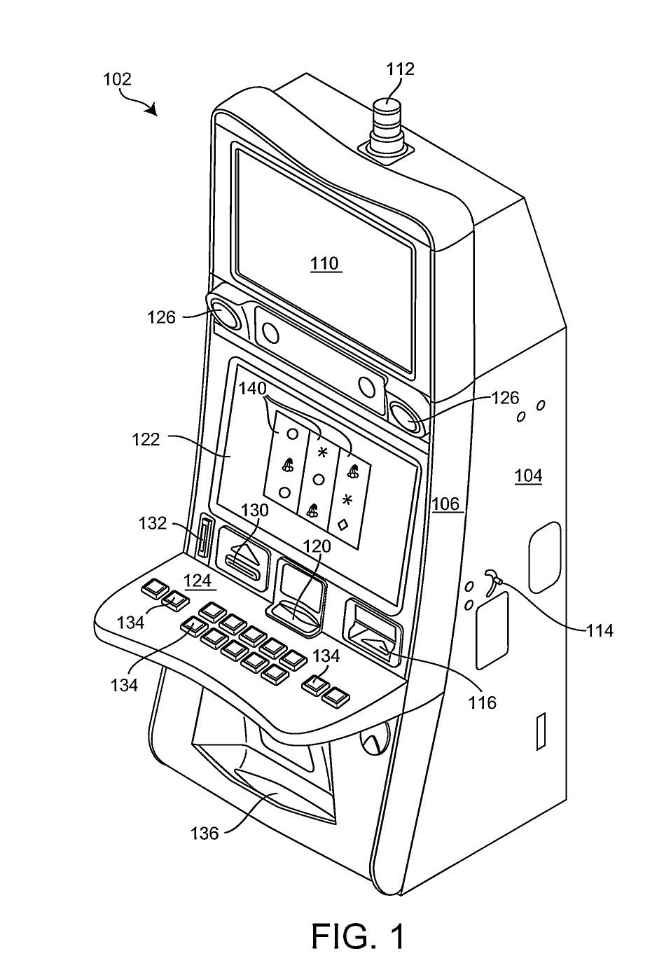

Referring to FIG. 1, a perspective drawing of an electronic gaming machine 102 is shown, in accordance with described embodiments. Gaming machine 102 may include a main cabinet 104. Main cabinet 104 may provide a secure enclosure that prevents tampering with device components, such as a game controller (not shown) located within the interior of main cabinet 104. Main cabinet 104 may include an access mechanism, such as a door 106, which allows the interior of gaming machine 102 to be accessed. Actuation of a door 106 may be controlled by a locking mechanism 114. In some embodiments, locking mechanism 114, door 106, and the interior of main cabinet 104 may be monitored with security sensors of various types to detect whether the interior has been accessed. For instance, a light sensor may be provided within main cabinet 104 to detect a change in light-levels when door 106 is opened and/or an accelerometer may be attached to door 106 to detect when door 106 is opened.

Gaming machine 102 may also include devices for conducting a wager-based game. For example, gaming machine 102 may include an acceptor 116 and a printer 120. In various embodiments, gaming machine 102 may be configured to run on credits that may be redeemed for money and/or other forms of prizes. Acceptor 116 may read an inserted ticket having one or more credits usable to play a game on gaming machine 102. For example, a player of gaming machine 102 may wager one or more credits within a video slot game. If the player loses, the wagered amount may be deducted from the player's remaining balance on gaming machine 102. However, if the player wins, the player's balance may be increased by the amount won. Any remaining credit balance on gaming machine 102 may be converted into a ticket via printer 120. For example, a player of gaming machine 102 may cash out of the machine by selecting to print a ticket via printer 120. The ticket may then be used to play other gaming machines or redeemed for cash and/or prizes. According to various embodiments, gaming machine 102 may record data regarding its receipt and/or disbursement of credits. For example, gaming machine 102 may generate accounting data whenever a result of a wager-based game is determined. In some embodiments, gaming machine 102 may provide accounting data to a remote data collection device, allowing the remote monitoring of gaming machine 102.

In some cases, gaming machine 102 may be configured to receive and/or dispense physical money or tokens used by the gaming establishment. For example, gaming machine 102 may include an acceptor 132 configured to receive coins or tokens. Similarly, gaming machine 102 may include a bill acceptor. For example, acceptor 116 may be configured to accept bills in addition to, or in lieu of, tickets. Money or tokens received by gaming machine 102 may be converted into game credits. In some embodiments, gaming machine 102 may be configured to dispense money or tokens via a coin hopper 136. For example, a player may cash out of gaming machine 102 by converting any remaining game credits into money or tokens dispensed via coin hopper 136. In some cases, a threshold amount may be used by gaming machine to control whether a redeemable ticket is printed by printer 120 or a payout is paid via coin hopper 136 (e.g., small payouts below a threshold dollar amount may be paid via coin hopper 136 while larger payouts are paid via a printed ticket).

In one embodiment, gaming machine 102 may include a loyalty card acceptor 130. In general, a loyalty card may be tied to a user's loyalty account. A loyalty account may store various information about the user, such as the user's identity, the user's gaming preferences, the user's gaming habits (e.g., which games the user plays, how long the user plays, etc.), or similar information about the user. A loyalty account may also be used to reward a user for playing gaming machine 102. For example, a user having a loyalty account may be given a bonus turn on gaming machine 102 or credited loyalty points for playing gaming machine 102. Such loyalty points may be exchanged for loyalty rewards (e.g., a free meal, a free hotel stay, free room upgrade, discounts, etc.).

Gaming machine 102 may include any number of user interface devices that convey sensory information to a user and/or receive input from the user. For example, gaming machine 102 may include electronic displays 110, 122, speakers 126, and/or a candle device 112 to convey information to the user of gaming machine 102. Gaming machine 102 may also include a console 124 having one or more inputs 134 (e.g., buttons, track pads, etc.) configured to receive input from a user. In one embodiment, display 110 and/or display 122 may also be a touch screen display configured to receive input from a user. A controller (not shown) within gaming machine 102 may run a game, such as a wager-based game, in response to receiving input from a user via inputs 134, display 110, or display 122. For example, inputs 134 may be operated to place a wager in the game and to run the game.

According to various embodiments, display 122 may be a video display having one or more selectably transparent window openings. In one mode of operation, at least a portion of display 122 may be transparent, allowing the player to view electro-mechanical reels 140. In various embodiments, 75% or more of light may be passed through the portion of display 122 when in a transparent state. For example, a player of gaming machine 102 may operate inputs 134 to initiate a spin in a slot-based game. In turn, electro-mechanical reels 140 may spin and be visible to the player through display 122. In areas outside of the one or more window openings, graphics and other forms of indicia may be displayed on display 122. For example, a payline graphic may be displayed on display 122 outside of the one or more window openings, indicating the line along which the symbols of electro-mechanical reels 140 must match for the player to receive a payout.

In a second mode of operation, the one or more window openings of display 122 may be closed, thereby obscuring electro-mechanical reels 140 from the player of gaming machine 102. While closed, graphics may be presented on display 122 over the window openings, causing display 122 to appear as a standard video display to the player. In one embodiment, the one or more window openings of display 122 may change between being transparent and closed within the same slot-based game. In another embodiment, gaming machine 102 may be configured to play a plurality of games, including one or more slot-based games that use electro-mechanical reels 140. For example, a video poker game may be presented on display 122 while the window openings of display 122 are closed and a slot-based game may be played on gaming machine 102 while the window openings of display 122 are transparent to allow a player to view electro-mechanical reels 140 during play.

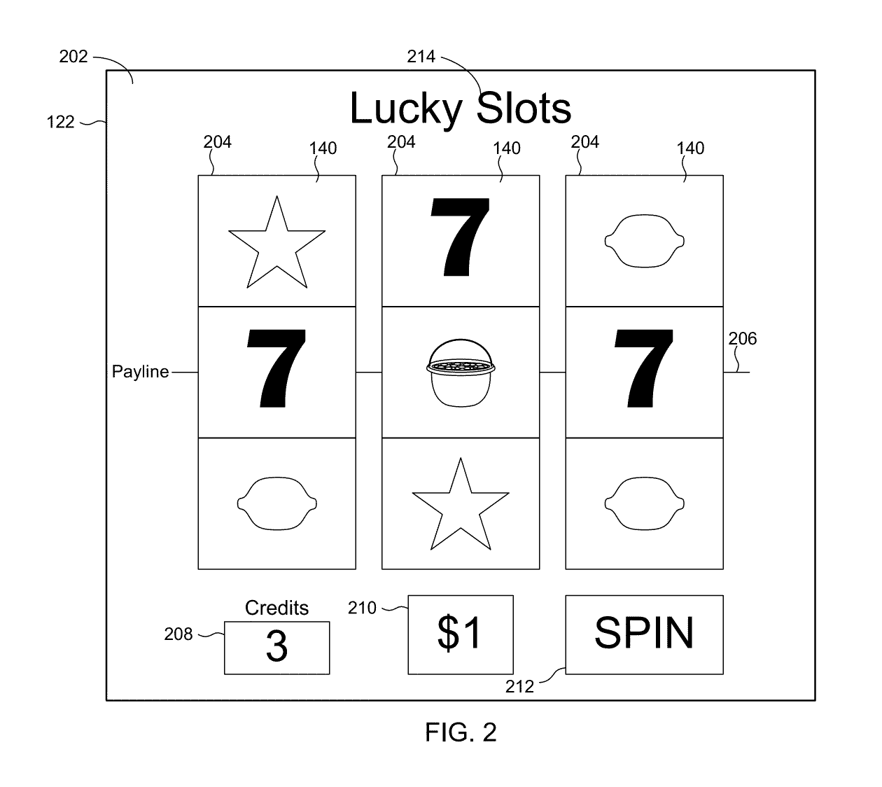

Referring now to FIG. 2, an illustration is shown of video display 122 from FIG. 1 in greater detail, according to one embodiment. As shown, gaming machine 102 may be in a state allowing a player to play a slot-based game (e.g., the game “Lucky Slots”). In various embodiments, display 122 includes an area 202 on which graphics may be displayed. For example, text 214 may be displayed in area 202 such as the title of the slot-based game. Display 122 may also include window openings 204 in which the display 122 may be selectably transparent. For example, electro-mechanical reels 140 may be visible through window openings 204 of display 122 when the slot-based game is being played. In one embodiment, a window opening may be opened (e.g., transparent) or closed upon entry of a bonus round. Processing circuitry of gaming machine 102 may determine that a bonus round is to be entered based on any number of factors (e.g., randomly, in response to the player achieving a certain in-game objective, based on the amount of gameplay by a player, etc.). In response, the processing circuitry may open or close window openings 204. For example, electro-mechanical reels 140 may be visible during normal game play and hidden from the player's view during a bonus round, or vice-versa. Any number of different types of gaming-related objects may be displayed in addition to, or in lieu of, electro-mechanical reels 140, according to various embodiments. For example, other forms of gaming-related objects may include, but are not limited to, roulette wheels, robotic arms, and other electro-mechanically controlled objects configured to move during gameplay.

Various graphics and other indicia may be displayed in area 202 of display 122 during game play. As shown, area 202 may display an indication 210 of the cost per spin of electro-mechanical reels 140 (e.g., each spin cost $1). Area 202 may also display an indication 208 of the number of credits available to the player of gaming machine 102. Each credit may correspond, for example, to the cost per spin indicated by indication 210. Area 202 may also display a payline 206. Payline 206 may overlap window openings 204 or may appear outside of window openings 204, in various embodiments. During game play, electro-mechanical reels 140 may spin, resulting in a combination of symbols to appear along payline 206. In some implementations, the combination of symbols may be determined using an RNG and virtual reels that map the random numbers to positions of electro-mechanical reels 140. A motor may then control electro-mechanical reels 140 to spin, eventually stopping at the positions determined from the virtual reels. While electro-mechanical reels 140 are spinning, window openings 204 may be transparent on display 122, allowing the player to view the results.

In one example of operation, an RNG first generates one or more random numbers when a round of the game is initiated. Next, the random numbers may be matched to positions of a virtual reel. Each position of the virtual reel may correspond to a position reels 140 shown to the player. Generally, a virtual reel has many more positions than the actual reel, allowing the probability of certain symbol combinations on the actual reels to vary. For example, a three reel slot machine having ten unique symbols per reel has total of 10*10*10=1,000 possible symbol combinations. If each possible outcome has the same probability, the probability of any given combination of symbols appearing would be 1:1,000 (e.g., the combination of symbols 7-7-7 would statistically appear once every thousand spins). Now, assume that each of reels 140 has an associated virtual reel with 100 positions and that each of the ‘7’ symbols has only one position on a virtual reel. In such a case, the probability of the combination of symbols 7-7-7 appearing on the actual reels would then be 1:100³=1:1,000,000. Thus, the probability of jackpots and other payouts in a game may be controlled via a virtual reel.

In some embodiments, display 122 may be a touch-sensitive display. Generally, a touch-screen display is configured to sense contact between a user and a portion of the display. For example, a touch-screen display may sense a difference in the capacitance or resistance across the display as a result of a user contacting a portion of the display. Other forms of touch-screen displays use acoustic sensors, infrared sensor, and other forms of sensors to detect contact between a user and a portion of the screen. As shown, a touch-sensitive button 212 may be displayed on display 122 (e.g., a “SPIN” button). In response to sensing contact between a user and the area of display 122 corresponding to button 212, the slot-based game may debit the player's total credits on gaming machine 102 and initiate a new round of play. For example, selection of button 212 on display 122 may cause electro-mechanical reels 140 to begin spinning, provided the player has the requisite number of credits remaining to play the game. If the symbols of electro-mechanical reels 140 along payline 206 correspond to a winning combination, gaming machine 102 may award additional credits to the player and/or dispense money or tokens to the player.

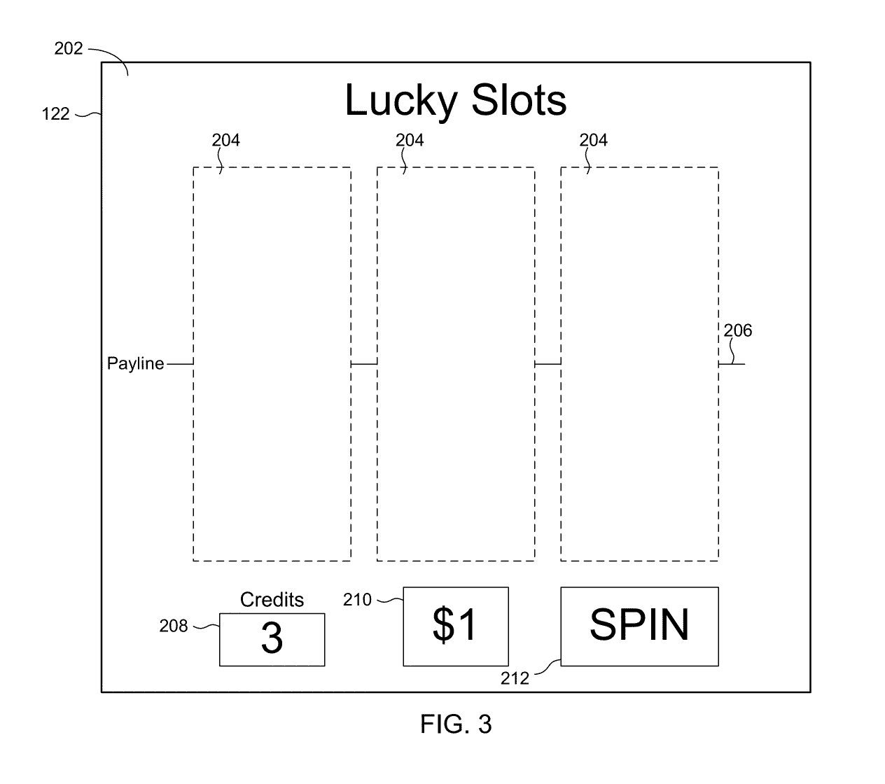

Referring now to FIG. 3, an illustration is shown of the window openings 204 of display 122 in a transparent state, according to an exemplary embodiment. In FIG. 3, display 122 is depicted without electro-mechanical reels 140 behind it. According to various embodiments, display 122 may include one or more electronic shutters configured to switch between a closed state and a transparent state. Application of an electric potential to such a shutter may cause the shutter to transition between the two states. As a result, window openings 204 may be switched between transparent and closed without having specific holes cut into the backlight unit (BLU) of display 122.

In one embodiment, display 122 may include one or more shutters made from a polymer dispersed liquid crystal (PDLC) film. Generally, a PDLC film is formed by encapsulating liquid crystals within a polymer and then sandwiching the PDLC between film or glass layers. The random alignment of the crystals may be such that light passing through the film is scattered, giving the film a highly scattered translucent characteristic when in a closed state. However, when a voltage is applied to such a film, the crystals align with the applied electric field and the film transitions into a transparent state. Thus, window openings 204 in display 122 may be made transparent by applying a voltage to the shutter or shutters corresponding to window openings 204. Similarly, the shutter or shutters corresponding to area 202 may be closed, allowing graphics displayed on display 122 to be more easily seen by a user. Alternatively, a film may be used that has dispersed liquid crystals that are naturally aligned, making the film naturally transparent without a voltage present. In such a case, a voltage may instead be applied to the film to toggle the film from its transparent state to its closed state.

Display 122 may include any number of selectably transparent areas via the inclusion of one or more electric shutters. In one example, the entirety of display 122 may be selectively made transparent. In another example, a single area of display 122 may be made transparent, to allow a player to view electro-mechanical reels 140 or other physical objects. In a further example, each of electro-mechanical reels 140 may have its own corresponding window opening (e.g., window openings 204), configured to be selectively transparent. In another example, the shutter can be controllable down to the pixel level and able to go transparent in any number of different window shapes to allow objects behind the shutter to be visible

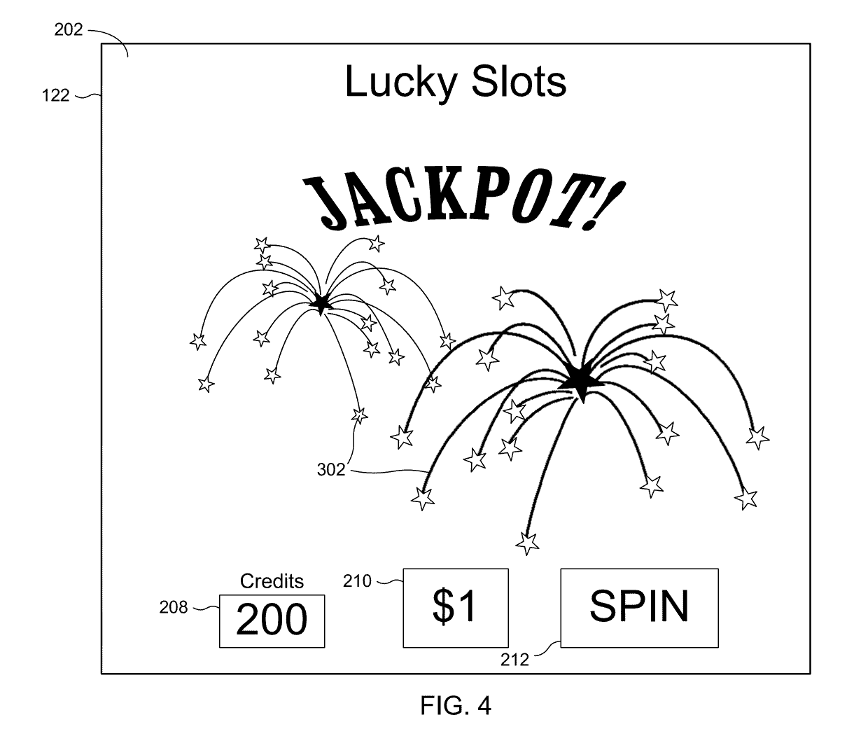

Referring now to FIG. 4, an illustration is shown of display 122 with window openings 202 in a closed state, according to an exemplary embodiment. In the example shown, the shutters corresponding to window openings 202 in FIG. 3 may be switched to a closed state, thereby obscuring a player's view through display 122. For example, electro-mechanical reels 140 may be concealed from the player when the one or more shutters of display 122 are in a closed state.

Various graphics may be displayed on display 122 in the area of window openings 202. For example, graphics 302 may be displayed on display 122 in the area of window openings 202. Graphics 302 may be provided to display 122 at any time, but may not be as visible while window openings 202 are in a transparent state. While window openings 202 are in a closed state, as shown, graphics 302 may appear to a player on display 122 as if display 122 were a traditional video display.

In one embodiment, graphics 302 may be part of the same slot-based game shown in FIGS. 2-3. For example, graphics 302 may be presented on display 122 when a player hits a jackpot in the game. In another embodiment, graphics 302 and/or other images displayed on display 122 may be part of another game available on gaming machine 102. For example, gaming machine 102 may also be configured to play a purely video-based game that does not use electro-mechanical reels 140 (e.g., a video poker game, a video slot game, etc.).

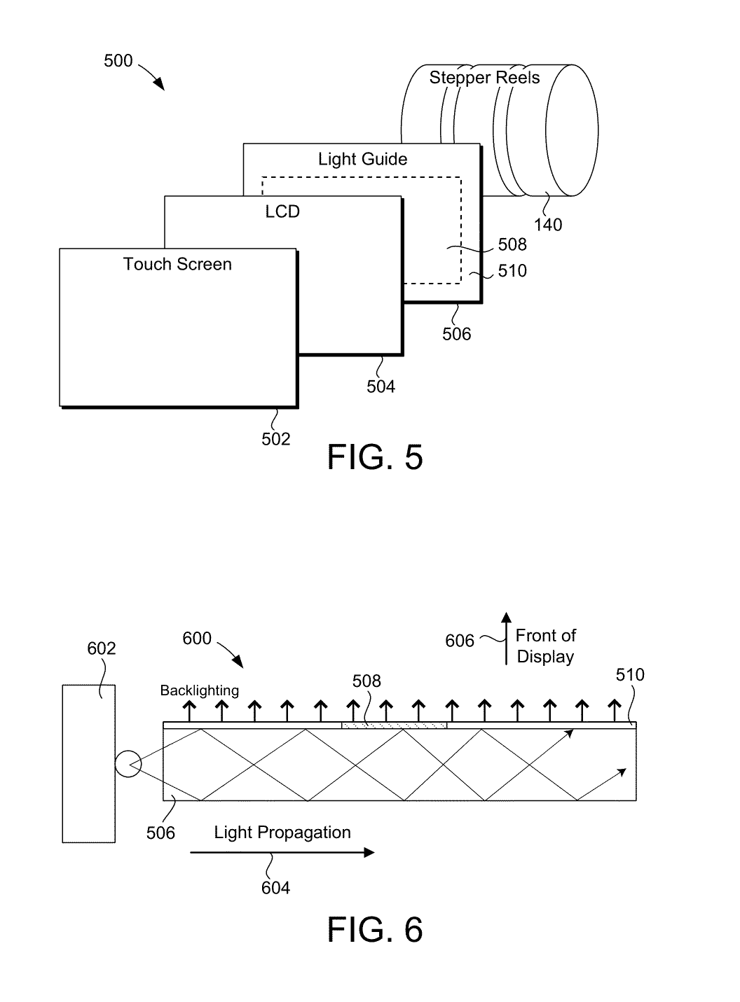

Referring now to FIG. 5, a schematic diagram 500 of a video display having a light guide shutter with a selectably transparent integrated shutter is shown, according to an exemplary embodiment. In general, the display allows for one or more window openings to become transparent in the light guide, allowing the user to see through at least a portion of the display. For example, reels 140 may be visible through the display when the one or more window openings are in a transparent state.

The display may include a graphic display portion 504 configured to provide display data to a user. As shown, graphic display portion 504 may be a liquid crystal display (LCD) screen, according to one embodiment. In other embodiments, graphic display portion 504 may be any other form of screen that utilizes backlighting. In further embodiments, graphic display portion 504 may be an emissive display that does not use backlighting. For example, display portion 504 may be a screen using organic light emitting diodes (OLED). Processing circuitry (e.g., a data processing apparatus) coupled to graphic display portion 504 may electronically control the colors generated by the LCD screen, thereby presenting various graphics and imagery to a user. For example, graphic display portion 504 may be controlled by the processing circuitry to display a video poker or slot-based game on the display.

According to various embodiments, the display may also include a light guide 506. In some embodiments, graphic display portion 504 may be backlit by one or more light sources that propagate light through light guide 506. For example, graphic display portion 504 may be illuminated by one or more light sources located along the edge of the screen. In such a case, light guide 506 may be configured to distribute light to more central areas of graphic display portion 504. Therefore, in one embodiment, the display may be a backlit LCD display. In other embodiments, the display may utilize another display technology that uses backlighting via a light guide.

Light guide 506 may include a light guide shutter 508 configured to selectably change between a closed state and a transparent state, thereby forming a window opening through the display when transparent. In one embodiment, light guide shutter 508 may be constructed using a PDLC film having a closed base state. However, when a voltage is applied to the PDLC film, light guide shutter 508 may transition into a transparent state, allowing a user to see through the display. In an alternate embodiment, light guide shutter 508 may be constructed using one or more layers of cholesteric liquid crystals (CLCs) sandwiched between transparent conductive layers (e.g., layers of indium tin oxide or other transparent conductive materials). Application or removal of a bias to the conductive layers cause the CLC layers to transition between allowing more or less light through, thereby opening or closing light guide shutter 508. Light guide 506 may include any number of light guide shutters, each controllable to be selectively transparent (e.g., the shutters may be electrically isolated from one another). For example, the display may have a single window opening to expose reels 140 or each of reels 140 may have its own separate window opening. Window openings in the display also may be controlled independently or in unison. For example, all of reels 140 may be exposed to a player by simultaneously controlling their corresponding window openings to be in a transparent state. In another example, only a subset of reels 140 may be exposed by allowing some of the corresponding window openings to remain in a closed state (e.g., one of reels 140 may become hidden when the game enters a bonus round). In another example, light guide shutter 508 may be controllable down to the pixel level such that any number of different pixels may be opened separately or in unison. Thus, any number of different window openings having any number of different shapes may be provided by light guide shutter 508 at any given time. According to various embodiments, light guide shutter 508 may also provide backlighting to LCD 504, while in a closed state. In other words, the selectably changeable portions of light guide shutter 508 may still operate as a light guide while in a closed state.

Light guide 506 may include an inactive area 510 that remains closed during operation of the display. In some embodiments, inactive area 510 may be a traditional light guide configured to direct and distribute backlighting behind graphic display portion 504. In such a case, inactive area 510 may include extraction features configured to more evenly distribute the backlighting behind graphic display portion 504. For example, inactive area 510 may have reflective dots or other reflective shapes configured to cause propagating light within light guide 506 to more evenly distribute the backlighting in the display. In another example, the extraction features of inactive area 510 may be etchings or a coating that causes light to propagate within light guide 506. In further embodiments, light guide shutters, such as light guide shutter 508, may provide the extraction features in inactive area 510. For example, inactive area 510 may include light guide shutters that are held in a closed state while light guide shutter 508 is open. In some embodiments, any number of light guide shutters may be included in light guide 506, down to the pixel level. Thus, the size and shape of inactive area 510 may be adjusted to create any number of different window openings of any number of different shapes.

According to some embodiments, the display may be a touch screen display that includes a touch screen portion 502. In general, touch screen portion 502 is configured to sense contact between a user and the display. For example, a button graphic may be displayed in an area of graphic display portion 504. Contact sensed by touch screen portion 502 between a user and the area may then be treated by the device as if the user had pressed a mechanically-based button. Touch screen portion 502 may use any number of touch-sensing techniques to sense contact between a user and the display. Such techniques may include, but are not limited to, sensing a difference in capacitance across touch screen portion 502, sensing a difference in resistance across touch screen portion 502, outputting an acoustic wave across touch screen portion 502 and sensing changes in the wave, outputting a light wave (e.g., an IR wave, etc.) across touch screen portion 502 and sensing changes in the wave, and combinations thereof

Generally, integrating light guide shutter 508 into the display allows for the display to have one or more selectably transparent window openings without having to cut one or more corresponding holes in graphic display portion 504 or the rest of the optical stack of the display. Also, no additional layers are required to be added to the display's optical stack to selectably control the transparency of a window opening through the display. Thus, the display may be constructed anew or, in some cases, by minimally modifying a traditional display. For example, a traditional backlit LCD display may be converted into a display with a selectably transparent window opening by removing its reflector (e.g., a reflective layer behind the display's backlighting light guide) and installing a controllable light guide shutter. In another example, a hole may be cut into the reflector in the area of a light guide shutter.

Referring now to FIG. 6, a diagram 600 is shown of light being propagated in a light guide, according to an exemplary embodiment. A light guide, such as light guide 506 shown in FIG. 5, generally operates to distribute light from a light source 602 across a display. Light source 602 may be any form of light source. For example, light source 602 may be, but is not limited to, an LED or a fluorescent lamp (e.g., a cold-cathode fluorescent lamp, a hot-cathode fluorescent lamp, etc.). While light source 602 is depicted as being located along the side of light guide 506 (e.g., the display uses edge-lit backlighting), light source 602 may be located in any number of locations relative to light guide 506, in other embodiments.

As shown, light generated by light source 602 may propagate in direction 604 through light guide 506, due to the internal reflection of light guide 506. Backlighting of the display is achieved by the propagating light being reflected/extracted towards the front of the display along direction 606. To more evenly distribute the light provided along direction 606, light guide 506 may include light extraction features to control the reflected light being propagated through light guide 506. As shown, the light extraction features may be placed along inactive portion 510. For example, a pattern of refractive dots may be located along direction 604 such that the dots closest to light source 602 have the lowest density per area and the dots farthest away from light source 602 and any other light sources have the highest density per area. In other implementations, light guide 506 may include etched features having extracting properties to control the propagation of light. Since areas of light guide 506 closest to light source 602 receive the greatest amount of light, less refractive material is needed in these areas to ensure light is refracted out of light guide 506 along direction 606. Conversely, areas farthest away from light source 602 may have a high amount of refractive material, to help evenly distribute the light intensity from these areas refracted out of light guide 506 along direction 606. In a further embodiment, the extraction features may be light guide shutters. For example, at least a portion of the light guide shutters may be held in a closed state (e.g., either permanently or selectably), thereby causing the light from light source 602 to be distributed within light guide 506. In other words, inactive portion 510 may be constructed in a manner similar to light guide shutter 508. In various embodiments, the light guide shutters may be configured to remain in the closed state (e.g., no voltage source is connected to the light guide shutters) or may be configured to be selectable (e.g., to form any number of different window openings of any number of different sizes and shapes).

Also shown is light guide shutter 508, which may be of any size ranging from a pixel to the entire surface of light guide 506. When light guide shutter 508 is in a transparent state, light propagated through light guide 506 continues propagating along direction 604 due to total internal reflection (TIR). However, when light guide shutter 508 is in a closed state, as shown in FIG. 6, it may act as an extraction feature causing the light to be transmitted towards the display. Light guide shutter 508 may allow light to pass through light guide 506, irrespective of whether or not light from light source 602 is present. In other words, a user may still be able to see through light guide shutter 508 when it is in its transparent state, regardless of whether light is being provided by light source 602. While light guide shutter 508 is depicted in diagram 600 as being located along the surface of light guide 506 closest to the display's screen, light guide shutters may also be located along any other surface of light guide 506, in other embodiments. For example, assume that light guide 506 is illuminated from another angle that differs from that of the side lighting by light source 602. In such a case, light guide shutters may be arranged along any of the surfaces of light guide 506 such that the light is more evenly distributed from the light source to the screen of the display by light guide 506.

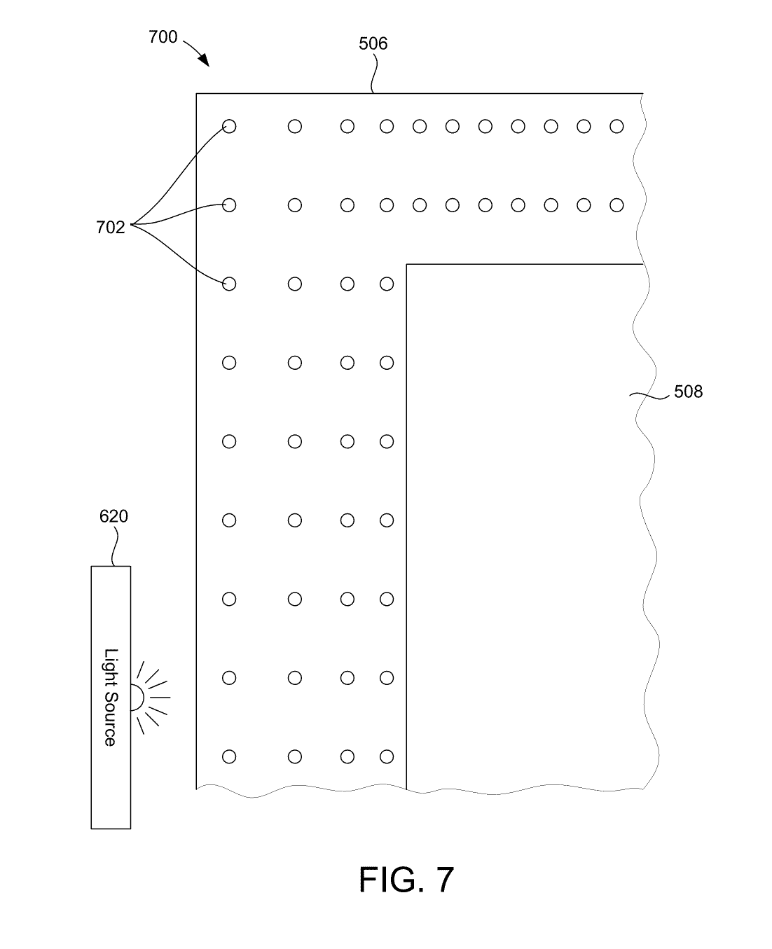

Referring now to FIG. 7, a diagram 700 is shown of a light guide having light extraction features, according to an exemplary embodiment. As shown, light guide 506 may include a pattern of extraction features 702 or other such shapes, to more evenly distribute light generated by light source 602 across the screen of the display. The density of extraction features 702 may be increased or decreased along light guide 506 with the distance from light source 602, thereby more evenly distributing the backlighting across the display. In some embodiments, extraction features 702 may be made from refractive material such as barium sulfate, titanium dioxide, calcium carbonate, or other such refractive material. In other embodiments, extraction features 702 may be etched patterns in light guide 506 configured to extract internally reflected light out of light guide 506. In further embodiments, extraction features 702 may be selectably controllable light guide shutters (e.g., light guide 506 may have multiple light guide shutters that are controlled to provide light more evenly to the display).

In some embodiments, extraction features 702 may be disbursed across inactive portion 510 of light guide 506 and not across light guide shutter 508. However, light guide shutter 508 itself may be configured to act as a light guide while in a closed state. In other words, light guide shutter 508 may still direct light from light source 602 towards the screen of the display while in its closed state. According to some embodiments, light guide shutter 508 may include electrochromic material configured to switch between two states when a voltage is applied. In one state, the electrochromic material may be transparent, allowing a player to see through light guide shutter 508. In another state, the electrochromic material may be reflective, such that light from light source 602 is reflected towards the screen of the display, when light guide shutter 508 is in a closed state. In one embodiment, extraction features 702 also may not extend through inactive portion 510 to be adjacent with light guide shutter 508, since extraction of light in the area of light guide shutter 508 may obscure a player's vision through light guide shutter 508 when in a transparent state. In a further embodiment, inactive portion 510 of light guide 506 may itself be constructed using a non-switchable PDLC or other shutter material.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular embodiments. Certain features that are described in this specification in the context of separate implementations or embodiments can also be implemented in combination in a single implementation. Conversely, various features that are described in the context of a single implementation or embodiment can also be implemented in multiple implementations or embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. An electronic display comprising:
a graphic display portion configured to display graphical indicia;
a light source; and
a light guide configured to receive light from the light source and provide the light as backlighting to the graphic display portion, wherein the light guide comprises a light guide shutter configured to selectably transition between a closed state and a transparent state, wherein the light guide shutter is configured to allow a user to see through the electronic display when the light guide shutter is in its transparent state, and wherein the light guide shutter diffuses the light to provide backlighting to the graphic display portion when the light guide shutter is in its closed state.

2. The electronic display of claim 1, wherein the graphic display portion comprises a liquid crystal display (LCD) or organic light emitting diode (OLED) panel.

3. The electronic display of claim 1, wherein the light guide shutter comprises a polymer dispersed liquid crystal (PDLC) film.

4. The electronic display of claim 1, wherein a transparent window opening is formed through the electronic display when a voltage is applied to the light guide shutter.

5. The electronic display of claim 1, wherein a transparent window opening is formed through the electronic display when a voltage is removed from the light guide shutter.

6. The electronic display of claim 1, wherein the light guide shutter comprises one of more layers of cholesteric liquid crystals (CLCs).

7. The electronic display of claim 6, further comprising conductive layers surrounding the one or more layers of CLCs, wherein the conductive layers are configured to transition the one or more layers of CLCs between the closed state and the transparent state when a voltage is applied to the conductive layers.

8. The electronic display of claim 7, wherein the conductive layers comprise a transparent material.

9. The electronic display of claim 1, wherein the light guide comprises light extraction features configured to direct the light from the light source.

10. The electronic display of claim 9, wherein the light extraction features comprise etchings or reflective material.

11. The electronic display of claim 9, wherein the light extraction features comprise light guide shutters.

12. The electronic display of claim 1, wherein the light guide shutter is configured to allow a user to see through the electronic display when the light guide shutter is in a transparent state irrespective of the light from the light source being received by the light guide.

13. The electronic display of claim 1, wherein the light guide shutter comprises an electrochromic material.

14. The electronic display of claim 1, further comprising:
a touch screen portion configured to sense contact between a user and the display.

15. The electronic display of claim 1, wherein a hole is not cut into the light guide for the light guide shutter.

16. The electronic display of claim 1, wherein the light guide comprises a plurality of light guide shutters configured to transition between transparent states and closed states.

17. The electronic display of claim 16, wherein the plurality of light guide shutters are controllable to form window openings through the display having different shapes or sizes.

18. The electronic display of claim 16, wherein each of the plurality of light guide shutters corresponds to a different pixel of the graphic display portion.

19. An electronic gaming machine comprising:
a cabinet;
an electronic display housed by the cabinet;
one or more electro-mechanically controlled devices housed by the cabinet and located between the electronic display and the cabinet; and
processing circuitry configured to provide graphics to the electronic display and to control the spinning of the one or more electro-mechanically controlled devices, wherein the electronic display comprises a light guide having a light guide shutter configured to selectably transition between a closed state and a transparent state, the electro-mechanically controlled devices being visible through a portion of the electronic display when the light guide shutter is in its transparent state, and the light guide providing backlighting to the electronic display when light guide shutter is in its closed state.

20. The electronic gaming machine of claim 19, wherein the electro-mechanically controlled devices comprise electro-mechanical slot reels.

21. The electronic gaming machine of claim 19, wherein the processing circuitry is configured to transition the light guide shutter between the closed state and the transparent state in response to a determination that a bonus round is being entered.

22. The electronic gaming machine of claim 19, wherein the electronic display comprises a liquid crystal display (LCD) panel or an organic light emitting diode (OLED) panel.

23. The electronic gaming machine of claim 19, wherein the light guide shutter comprises a polymer dispersed liquid crystal (PDLC) film.

24. The electronic gaming machine of claim 19, wherein the light guide shutter comprises one of more layers of cholesteric liquid crystals (CLCs).

25. The electronic gaming machine of claim 24, further comprising conductive layers surrounding the one or more layers of CLCs, wherein the conductive layers are configured to transition the one or more layers of CLCs between the closed state and the transparent state when a voltage is applied to the conductive layers.

26. The electronic gaming machine of claim 19, further comprising means for directing light from a light source to the electronic display.

27. The electronic gaming machine of claim 19, wherein the light guide shutter comprises an electrochromic material.

28. The electronic gaming machine of claim 19, wherein the light guide shutter is configured to allow a user to see through the electronic display when the light guide shutter is in a transparent state irrespective of the light from the light source being received by the light guide.

29. The electronic display of claim 19, wherein the light guide comprises a plurality of light guide shutters configured to transition between transparent states and closed states.

30. The electronic display of claim 29, wherein each of the plurality of light guide shutters corresponds to a different pixel of the graphic display portion.

31. The electronic gaming machine of claim 19, wherein the electronic display comprises a touch-screen portion configured to receive input via sensed contact with the electronic display.

32. A light guide configured to receive light from a light source and provide the light as backlighting to an electronic display, the light guide comprising:
an inactive portion having light extraction features configured to direct the light received from the light source; and
a light guide shutter configured to selectably transition between a closed state and a transparent state, wherein the light guide shutter is configured to allow a user to see through the electronic display when the light guide shutter is in its transparent state, and wherein the light guide shutter is configured to direct light as backlighting to the graphic display portion when the light guide shutter is in its closed state
